(19) United States
(12) Patent Application Publication
(10) Pub. No.: US 2007/0259320 A1
(43) Pub. Date: Nov. 8, 2007

(54) Teaching children a targeted life skill in a soft contained play center

(76) Inventor: Samuel B. Kellett, Atlanta, GA (US)

Correspondence Address: Kangaroo Bob's, LLC, c/o Biggers & Ohanlan, LLP, P.O. Box 1469, Austin, TX, 78767-1469, US

(21) Appl. No.: 11/416,688

(22) Filed: May 3, 2006

(51) Int. Cl. G09B 19/00

(52) U.S. Cl. 434/237

(57) ABSTRACT

Methods for teaching children a targeted life skill in a soft contained play center. Embodiments include selecting an athletic game, wherein success in playing the selected athletic game is predetermined to be linked to exhibiting one or more predefined aspects of the particular life skill; wherein the selected athletic game is designed to be played in a soft contained play center including inflatable play areas; explaining to the children the rules of the selected athletic game; explaining to the children the one or more predefined aspects of the targeted life skill linked to success in playing the selected athletic game; administering the playing of the selected athletic game by the children in a soft contained play center; and rewarding each child for each of the predefined aspects of the particular life skill exhibited while playing the selected athletic game.

### BACKGROUND OF THE INVENTION

1. Field of the Invention

The field of the invention is data processing, or, more specifically, methods, systems, and products for teaching children a targeted life skill in a soft contained play center.

2. Description of Related Art

Children enjoy playing on inflatable play areas often found in recreational centers for children. Such recreational centers often provide for a fee unstructured play for children. While the children may enjoy playing on the inflatable play areas, their caregivers often see this activity only as play and not as education. There is therefore an ongoing need for improvement in the area of conventional recreation centers.

### SUMMARY OF THE INVENTION

Methods for teaching children a targeted life skill in a soft contained play center. Embodiments include selecting an athletic game, wherein success in playing the selected athletic game is predetermined to be linked to exhibiting one or more predefined aspects of the particular life skill; wherein the selected athletic game is designed to be played in a soft contained play center including inflatable play areas; explaining to the children the rules of the selected athletic game; explaining to the children the one or more predefined aspects of the targeted life skill linked to success in playing the selected athletic game; administering the playing of the selected athletic game by the children in a soft contained play center; and rewarding each child for each of the predefined aspects of the particular life skill exhibited while playing the selected athletic game.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth block diagram illustrating the layout of an exemplary soft contained play center according to the present invention.

FIG. 2 sets forth a flow chart illustrating an exemplary method for teaching children a targeted life skill in a soft contained play center according to the present invention.

FIG. 3 sets forth a block diagram illustrating aspects of athletic games useful in teaching children a targeted life skill in a soft contained play center according to the present invention.

FIG. 4 sets forth a flow chart illustrating an exemplary service for educating children on targeted life skills in a soft contained play center.

### DETAILED DESCRIPTION OF EXEMPLARY EMBODIMENTS

### Detailed Description

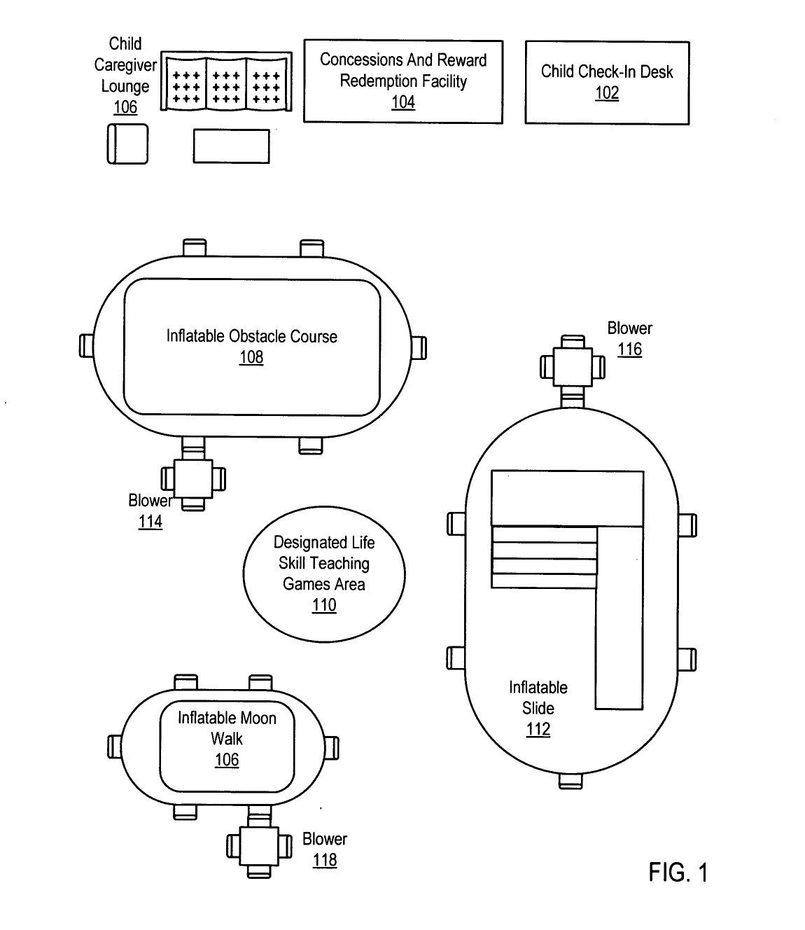

Exemplary methods and services for teaching children a targeted life skill in a soft contained play center according to embodiments of the present invention are described with reference to the accompanying drawings, beginning with FIG. 1. FIG. 1 sets forth a block diagram of a soft contained play center according to the present invention. A soft contained play center is a recreational area for children containing one or more inflatable play areas. Soft contained play centers according to the present invention include both indoor recreational areas having inflatable play areas and outdoor recreational areas having inflatable play areas. The exemplary soft contained play center of FIG. 1 is configured to teach children a targeted life skill according to the present invention.

The soft contained play of FIG. 1 includes a plurality of inflatable play areas (106, 108. and 112). Inflatable play areas are inflated structures typically made of vinyl, typically inflated with air by one or more blowers, and often designed according to a theme. The inflatable play areas of FIG. 1 includes an inflatable obstacle course (108) inflated by blower (114), an inflatable slide (112) inflated by blower (116), and an inflatable moon walk (106) inflated by blower (118).

The inflatable obstacle course (108, inflatable slide (112), and inflatable moonwalk (106) are presented for explanation and not for limitation. In fact, soft contained play centers may include any number of different kinds inflatable play areas such as inflatable boxing rings, castles, sport cages, basketball courts, gladiator coliseums, mountains, mazes, bouncers, jumpers, and many others as will occur to those of skill in the art.

The soft contained play center of FIG. 1 includes a designated games area (110). The designated games area (10) is a predetermined portion of the soft contained play center configured for teaching children a targeted life skill according to the present invention. A life skill is a trait of adults identified as beneficial to the success or well being of the adult. Examples of such life skills include teamwork, manners, self confidence, honesty, trustworthiness, and many others as will occur to those of skill in the art. Many such targeted life skills may be taught in a soft contained play center according to the present invention.

A life skill has one or more related aspects. Aspects of a life skill are specific characteristics of that life skill. For example, some aspects of the life skill of teamwork include hard work, closeness, leadership, reliability, working together, enthusiasm, emotional control, awareness, no fear of failure, determination, talent, training, team spirit, preparedness, principled, being the best that one can, as well as others as will occur to those of skill in the art.

The soft contained play center of FIG. 1 is configured for teaching children a targeted life skill by selecting an athletic game designed to be played in a soft contained play center either in a designated games area (110) or on one or more inflatable play areas (106, 108, 112). Success in playing the selected athletic game is predetermined to be linked to exhibiting one or more predefined aspects of the particular life skill to be taught in the soft contained play center. The soft contained play center of FIG. 1 is also configured for teaching children a targeted life skill by explaining to the children the rules of the selected athletic game, explaining to the children the one or more predefined aspects of the targeted life skill linked to success in playing the selected athletic game, administering the playing of the selected athletic game by the children in a soft contained play center, and rewarding each child for each of the predefined aspects of the particular life skill exhibited while playing the selected athletic game.

The soft contained play center of FIG. 1 also includes a child caregiver lounge (106). A child caregiver lounge (106) is an area designed for caregivers of children to wait, work, or relax while instructors of the soft contained play center administer structured and unstructured play of the children including teaching children a targeted life skill according to the present invention

The soft contained play center of FIG. 1 also includes a concessions and reward redemption facility (104). Concessions and reward redemption facility (104) includes concessions for sale and prizes to be redeemed by children having exhibited aspects of the one or more life skill taught in the soft contained play center. Rewards such as prizes may be redeemed from redeemable rewards, such as tickets for example, received by a child from an instructor for exhibiting predefined aspects of one or more life skills while playing selected athletic games in the soft contained play center.

The soft contained play center of FIG. 1 also includes a child check-in desk (102). The child check-in desk (102) is typically located near the entrance of the soft contained play center and is used to accept entrance of the child in the soft contained play center. In some soft contained play centers according to the present invention, each child is tagged with an Radio Frequency Identification (‘RFID’) tag that sets off an alarm if the child leaves the soft contained play center while wearing the RFID tag.

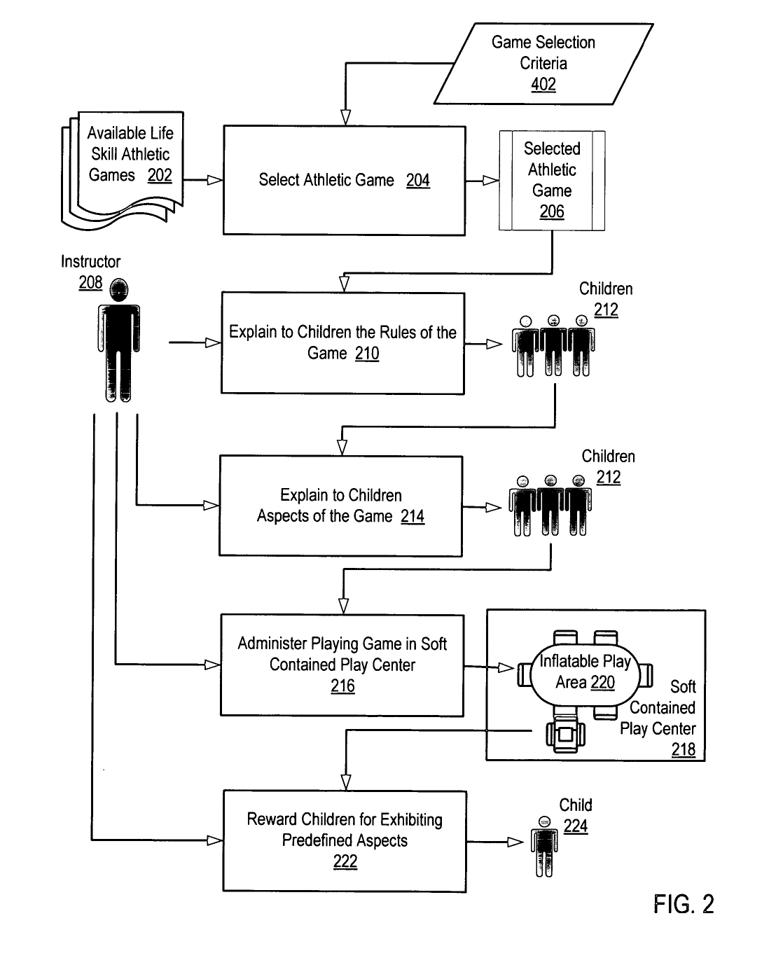

Soft contained play centers according to the present invention are configured for teaching children a targeted life skill according to the present invention. For further explanation, FIG. 2 sets forth a flow chart illustrating an exemplary method for teaching children a targeted life skill in a soft contained play center according to the present invention. The method of FIG. 2 includes selecting (204) an athletic game (206) designed to be played in a soft contained play center (218) including inflatable play areas (220). Such athletic games are designed to be played in designated areas in the soft contained play center or on one or more inflatable play areas in the soft contained play center. The selected athletic games are also designed with specific physical activities demonstrating one or more individual aspects of the life skill taught through the game. The rules of the selected athletic game are typically designed such that success in playing the selected athletic game (206) is predetermined to be linked to exhibiting one or more predefined aspects of the particular life skill by exhibiting the physical activities demonstrating those predefined aspects.

Often athletic games selected according to the method of FIG. 2 are themed athletic games targeted at a particular life skill and targeted for children of a particular ages and skill levels. In the example of FIG. 2, selecting (204) an athletic game (206) according to the method of FIG. 2 is carried out in dependence upon game selection criteria (402). Game selection criteria (402) are factors for determining which athletic game to select for teaching the targeted life skill and when to select the athletic game. Examples of game selection criteria include the number of children to play the game, the ages of the children to play the game, a game history including which games have been played and when the games are played, the competence of the instructors available to administer the game, the type of game played during a game selection time period, and others as will occur to those of skill in the art.

Soft contained play center may provide a curriculum of aspects of the predefined life skill. Such a curriculum may be taught by playing a plurality of games that together cover the aspects of the life skill comprising the life skill. Selecting an athletic game may therefore also include selecting a game from a plurality of games in dependence upon the aspects of the life skill taught by the game and a life skill curriculum.

To keep children interested in playing the athletic games and therefore in learning the targeted life skill, selecting an athletic game according to the present invention may include periodically selecting an athletic game at predetermined incremental time periods. The incremental time period, such as for example, every 15 minutes, is typically designed to facilitate the interest of the child in the game and also provide repetition for learning the life skill.

Teaching children a targeted life skill in a soft contained play center according to the method of FIG. 2 also includes explaining (210) to the children (212) the rules of the selected athletic game (206). Explaining the rules of the game to the children according to the method of FIG. 2 may include telling a predetermined story designed to explain the rules of the game. Telling a predetermined story designed to explain the rules of the game advantageously holds the attention of children thereby increasing the ability of the children to learn the rules of the game.

The method of FIG. 2 also includes explaining (214) to the children (212) the one or more predefined aspects of the targeted life skill linked to success in playing the selected athletic game (206). Explaining to the children the one or more predefined aspects of the targeted life skill linked to success in playing the game may also include telling a predetermined story designed to explain the one or more aspects of the targeted life skill to be rewarded. Telling a predetermined story designed to explain the one or more predefined aspects of the targeted life skill linked to success in playing the game advantageously holds the attention of children thereby increasing the ability of the children to learn the predefined aspects of the targeted life skill linked to success in playing the game.

The method of FIG. 2 also includes administering (216) the playing of the selected athletic game (206) by the children in a soft contained play center (218). In the method of FIG. 2, administering the playing of the selected athletic game in a soft contained play center is carried out by an instructor (208) of the soft contained play center. Administering the playing of the selected athletic game in a soft contained play center may be carried out by supervising the playing of the game in a designated game area in a soft contained play center, supervising the playing of the game on inflatable play areas in a soft contained play center.

Some athletic games useful in teaching children a targeted life skill in a soft contained play center according to the present invention may be team games having more than one team. In such cases, administering (216) the playing of the selected athletic game (206) by the children in a soft contained play center (218) typically includes assigning the children to one or more teams. Assigning the children to one or more teams may be carried out by assigning children to one or more teams in dependence upon a number of factors such as the age of the children, the type of selected game, the physical attributes of the individual children, the accomplishments with regard to a curriculum of the individual children, and many more as will occur to those of skill in the art.

Children often learn through repetition. Administering (216) the playing of the selected athletic game (206) by the children in a soft contained play center (218) may also include playing the game for a predetermined number of times. Playing a set of the game, that is, playing the game for a predetermined number of times advantageously reinforces the aspects of the life skill taught through the playing of the game.

The method of FIG. 2 also includes rewarding (222) one or more children (224) for one or more of the predefined aspects of the particular life skill exhibited while playing the selected athletic game (206). Predefined aspects of the particular life skill are exhibited by performing one or more defined physical activities in the selected athletic game that demonstrate the aspects of the life skill. For example, in a ball game for teaching teamwork, the physical activity of passing a ball may demonstrate the aspect of working together.

One way of rewarding (222) one or more children (224) for one or more of the predefined aspects of the particular life skill exhibited while playing the selected athletic game (206) may be carried out by providing the child with a reward redeemable for a prize. Redeemable rewards may often be combined with other redeemable rewards for a prize. Such a redeemable reward may be implemented through one or more tickets that may be redeemed for a prize made available by the soft contained play center. Prizes of higher value are typically available for more tickets than prizes of lower value. The use of redeemable rewards provides a vehicle for rewarding the child with a prize that the child finds most satisfying thereby increasing the reinforcement of the life shill taught through the method of FIG. 2.

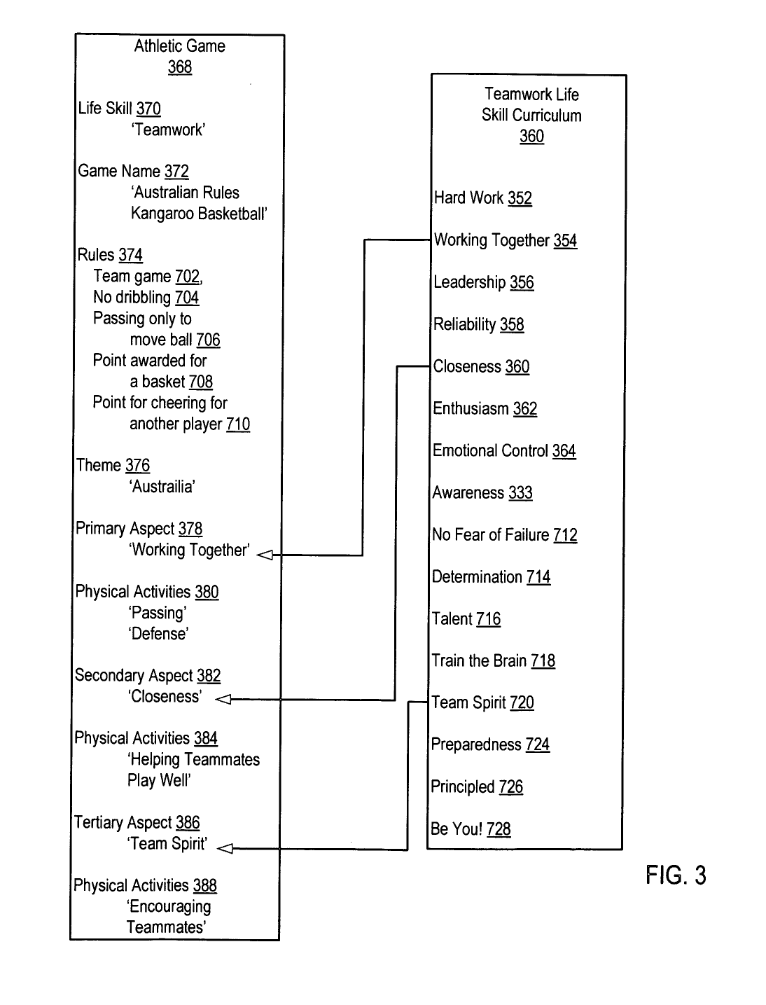

As discussed above, often athletic games selected according to the present invention are themed athletic games targeted at a particular life skill. For further explanation, therefore, FIG. 3 sets forth a block diagram illustrating a specific example of an athletic game useful in teaching children a targeted life skill in a soft contained play center according to the present invention. In the example of FIG. 3, the athletic game (368) is designed for teaching the life skill (370) ‘Teamwork’ and has a game name (372) of ‘Australian Rules Kangaroo Basketball.’

The exemplary athletic game (368) of FIG. 3 includes rules (374) designed such that success in playing Australian Rules Kangaroo Basketball is predetermined to be linked to exhibiting three aspects of teamwork. The three aspects of teamwork linked to success in the game and are ‘Working Together,’‘Closeness,’ and ‘Team Spirit.’ The rules (374) of the exemplary athletic game (368) of Australian Rules Kangaroo Basketball define the game as a team game (702) wherein no dribbling of the basketball is allowed (704) and players may only advance or move the ball by passing (706) to one another. The rules (374) of the exemplary athletic game (368) of Australian Rules Kangaroo Basketball also reward a point to a player that shoots the ball in a basket (708) and a point for cheering for another player (710).

The exemplary athletic game (368) of Australian Rules Kangaroo Basketball includes a theme (376) of ‘Australia.’ Themed games advantageously provide additional enjoyment to the children, help the children remember the rules of the game, and help to make apparent to the children the aspects of the targeted life skill enhanced through the game.

As mentioned above, the exemplary athletic game (368) Australian Rules Kangaroo Basketball includes rules (374) designed such that success in playing the game is predetermined to be linked to exhibiting three aspects of teamwork. The three aspects of teamwork supported by the rules include a primary aspect (378) ‘Working Together.’ Demonstrating a primary aspect (378) of the targeted life skill (370) is predetermined to provide more success in playing the athletic game than other a secondary aspects or tertiary aspects. The aspect (378) of ‘Working Together’ has associated physical activities (380) that exhibit the aspect. The physical activities (380) of ‘Passing’ and playing ‘Defense’ are exhibit the aspect of ‘Working Together.’

The three aspects of teamwork supported by the rules of Australian Rules Kangaroo Basketball include a secondary aspect (382)‘Closeness.’ Demonstrating the secondary aspect (382) of the targeted life skill (370) is typically predetermined to provide success in playing the athletic game but less success than the primary aspect. The secondary aspect (382) of ‘Closeness’ has associated physical activities (384) that exhibit the secondary aspect. The physical activities (384) of ‘Helping Teammates Play Well’ exhibit the secondary aspect of ‘Closeness.’

The three aspects of teamwork supported by the rules of Australian Rules Kangaroo Basketball also include a tertiary aspect (386) ‘Team Spirit.’ Demonstrating the tertiary aspect (386) of the targeted life skill (370) is typically predetermined to provide success in playing the athletic game but less success than the primary aspect and the secondary aspect. The tertiary aspect (386) of ‘Team Spirit’ has associated physical activities (388) that exhibit the tertiary aspect. The physical activities (388) of ‘Cheering for Teammates’ is defined to exhibit the tertiary aspect of ‘Team Spirit.’

The three aspects of teamwork of Australian Rules Kangaroo Basketball are three aspects of team work that are included in a plurality of aspects of teamwork that define a teamwork life skill curriculum (360). A curriculum of aspects is a defined plurality of aspects of a particular life skill. Such a curriculum is useful is selecting games such that the games together exhibit all the aspects of the curriculum. Following a curriculum also provides a structured way of teaching children many aspects of a particular targeted life skill and therefore teaching the children the life skill itself. The exemplary teamwork life skill curriculum (360) of FIG. 3 includes hard work (352), working together (354), leadership (356), reliability (358), closeness (360), enthusiasm (362), emotional control (364), awareness (333), no fear of failure (712), determination (714), talent (716), train the brain (718), team spirit (720), preparedness (724), principled (726), and be you (728).

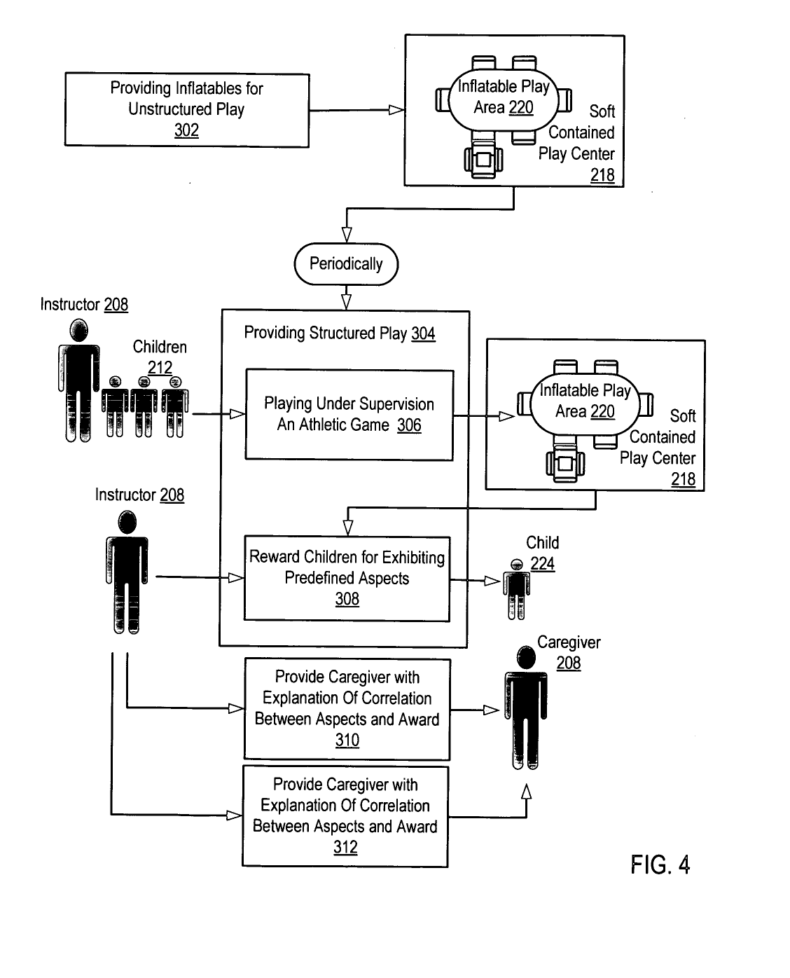

As discussed above, soft contained play centers often provide a service for educating children on targeted life skills. For further explanation, therefore, FIG. 4 sets forth a flow chart illustrating an exemplary service for educating children on targeted life skills in a soft contained play center. The service of FIG. 4 includes providing (302) inflatable play areas (220) for unstructured play for a children. Unstructured play advantageously improves the ability of a soft contained play center to usefully teach targeted life skills by allowing periodic freedom of play and, in some sense, a break from the lessons of the targeted life skill.

The service of FIG. 4 also includes periodically providing (304) structured play. Structured play according to the service of FIG. 4 includes playing (306) under supervision an athletic game in the soft contained play center (218), wherein success in playing the athletic game is predetermined to be linked to exhibiting one or more predefined aspects of the particular life skill. Playing under supervision an athletic game according to the service of FIG. 4 may be carried out by selecting the athletic game, explaining the rules of the game to the children, and explaining to the children the one or more predefined aspects of the targeted life skill linked to success in playing the game as discussed above with reference to FIG. 2.

Structured play according to the service of FIG. 4 also includes rewarding (308) one or more children (224) for one or more of the predefined aspects of the particular life skill exhibited while playing the selected athletic game. One way of rewarding (308) one or more children (224) for one or more of the predefined aspects of the particular life skill exhibited while playing the selected athletic game may be carried out by providing the child with a reward redeemable for a prize as discussed above with reference to FIG. 2.

The service of FIG. 4 also includes providing (310) to a caregiver (208) an explanation of the correlation between the child's exhibition of the aspects of the life skill and the reward. A caregiver is the caretaker of a child. Caregivers include parents, grandparents, relatives, friends, nannies, baby-sitters, and any other caretaker of a child that will occur to those of skill in the art. Providing (310) to a caregiver (208) an explanation of the correlation between the child's exhibition of the aspects of the life skill and the reward advantageously provides to the caregiver evidence that the cost and time spent at the soft contained play center is well spent.

The service of FIG. 4 also includes providing (312) to a caregiver an explanation of the correlation between the aspects of the life skill and the life skill. Providing (312) to a caregiver an explanation of the correlation between the aspects of the life skill and the life skill advantageously provides to the caregiver evidence that the cost and time spent at the soft contained play center is well spent.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for teaching children a targeted life skill in a soft contained play center, the method comprising:
selecting an athletic game, wherein success in playing the selected athletic game is predetermined to be linked to exhibiting one or more predefined aspects of the particular life skill; wherein the selected athletic game is designed to be played in a soft contained play center including inflatable play areas;
explaining to the children the rules of the selected athletic game;
explaining to the children the one or more predefined aspects of the targeted life skill linked to success in playing the selected athletic game;
administering the playing of the selected athletic game by the children in a soft contained play center; and
rewarding one or more children for one or more of the predefined aspects of the particular life skill exhibited while playing the selected athletic game.

2. The method of claim 1 wherein the targeted life skill comprises teamwork.

3. The method of claim 1 wherein the selected athletic game further comprises a themed game having one or more components of the theme, each component of the theme based upon the one or more predefined aspects of the targeted life skill linked to success in playing the game.

4. The method of claim 1 wherein the athletic game is designed to be played on one or more inflatable play areas in a soft contained play center.

5. The method of claim 1 wherein success in playing the athletic game is predetermined to be linked to a primary aspect of the targeted life skill and linked to one or more secondary aspects of the targeted life skill.

6. The method of claim 1 wherein selecting a game further comprises selecting a game from a plurality of games, wherein success in playing each of the athletic games is predetermined to be linked to exhibiting one or more predefined aspects of the particular life skill and the one or more predefined aspects of all the athletic games together comprise a life skill curriculum.

7. The method of claim 1 wherein selecting an athletic game further comprises periodically selecting an athletic game at incremental time periods.

8. The method of claim 1 wherein explaining the rules of the game to the children further comprises telling a predetermined story designed to explain the rules of the game.

9. The method of claim 1 wherein explaining to the children the one or more predefined aspects of the targeted life skill linked to success in playing the game further comprises telling a predetermined story designed to explain the one or more aspects of the targeted life skill to be rewarded.

10. The method of claim 1 wherein administering the playing of the selected athletic game in a soft contained play center further comprises supervising the playing of the game in a designated game area in a soft contained play center that includes plurality of inflatable play areas.

11. The method of claim 1 wherein administering the playing of the selected athletic game further comprises supervising the playing of the game on one or more inflatable play areas in a soft contained play center.

12. The method of claim 1 wherein administering the playing of the selected athletic game by the children in a soft contained play center further comprises assigning the children to one or more teams.

13. The method of claim 1 wherein administering the playing of the selected athletic game by the children in a soft contained play center further comprises repeating for a predetermined number of times the playing of the athletic game.

14. The method of claim 1 wherein rewarding one or more children for one or more of the predefined aspects of the particular life skill exhibited while playing the selected athletic game further comprises providing the child with a reward redeemable for a prize.

15. A service for educating children on targeted life skills in a soft contained play center, the method comprising:
providing inflatable play areas for unstructured play for a children;
periodically providing structured play; wherein the structured play includes:
playing under supervision an athletic game in the soft contained play center, wherein success in playing the athletic game is predetermined to be linked to exhibiting one or more predefined aspects of the particular life skill; and
rewarding one or more children for one or more of the predefined aspects of the particular life skill exhibited while playing the selected athletic game.

16. The service of claim 15 wherein playing under supervision an athletic game further comprises:
selecting the athletic game;
explaining the rules of the game to the children;
explaining to the children the one or more predefined aspects of the targeted life skill linked to success in playing the game;

17. The service of claim 15 further comprising providing to a caregiver an explanation of the correlation between the child's exhibition of the aspects of the life skill and the reward.

18. The service of claim 15 further comprising providing to a caregiver an explanation of the correlation between the aspects of the life skill and the life skill.

19. The service of claim 15 wherein the life skill comprises teamwork.

20. A soft contained play center, the soft contained play center comprising:
one or more inflatable play areas; and
a reward redemption facility;
the soft contained play center configured for teaching children a targeted life skill including:
selecting an athletic game, wherein success in playing the selected athletic game is predetermined to be linked to exhibiting one or more predefined aspects of the particular life skill; wherein the selected athletic game is designed to be played in a soft contained play center including inflatable play areas;
explaining to the children the rules of the selected athletic game;
explaining to the children the one or more predefined aspects of the targeted life skill linked to success in playing the selected athletic game;
administering the playing of the selected athletic game by the children in a soft contained play center; and
rewarding one or more children for one or more of the predefined aspects of the particular life skill exhibited while playing the selected athletic game.
